(19) United States
(12) Patent Application Publication
(10) Pub. No.: US 2015/0230493 A1
(43) Pub. Date: Aug. 20, 2015

(54) METHOD FOR PREPARING A LONG COFFEE WITH CREMA FROM A CAPSULE IN A CENTRIFUGAL COFFEE MACHINE, CAPSULE AND LIQUID COFFEE EXTRACT THEREOF

(71) Applicant: NESTEC S.A., Vevey (CH)

(72) Inventors: Alexis Alberto Rodriguez Rodriguez, Epalinges (CH); Anton Egli, Yverdon-Ies-Bains (CH); Florent Lefebre-Pautigny, Publier (FR); Anthony Bessant, Ies Pontets (FR); Tatiana Isabel Jerez Acevado, Lausanne (CH); Victoria Cortes Narvaez, Echallens (CH); Stephanie Ribeiro, La Tour-de-Peilz (CH); Diana Ribeiro, La Tour-de-Peilz (CH); Philippe Kessler, St-Aubin (CH)

(21) Appl. No.: 14/624,725

(22) Filed: Feb. 18, 2015

(30) Foreign Application Priority Data
Feb. 19, 2014 (EP) 14155811.4

(51) Int. Cl. A23F 5/36

(52) U.S. Cl. CPC A23F 5/36

(57) ABSTRACT

Method for producing a long coffee extract from a capsule in a coffee machine comprising: providing a capsule containing a predetermined dose of roast and ground coffee and the machine supplying hot water within the capsule, extracting liquid coffee extract from the capsule by rotating the capsule about its central axis in the machine for centrifuging and extracting the liquid coffee extract towards the periphery of the capsule while the machine continuing supplying hot water, the machine collecting the liquid coffee extract from the capsule and dispensing the coffee extract in a receptacle; wherein the liquid coffee extract is formed with coffee foam (i.e., ‘crema’) which exhibits, in a receptacle of reference, an initial height higher than 15 mm in the receptacle, such coffee foam being stable by retaining more than 50% of its initial height at 180 seconds after extraction and, wherein the roast and ground coffee has a weight of from 11 to 14 grams, a mean particle size D_{4,3} of from 200 to 500 micrometer and a roasting degree of from 50 to 80 CTN.

### PRIORITY CLAIM

The present application claims priority to European Patent Application No. 14155811.4, filed on February 19, 2014, the entire contents of which are being incorporated herein by reference.

### FIELD

The present invention relates to the field of preparation of coffee beverages by a coffee machine using capsules. The invention more particularly relates to a method and capsule for producing a long liquid coffee extract having a thick and stable head of coffee foam (‘crema’). The invention also relates to a liquid coffee extract with crema.

### BACKGROUND

The preparation of coffee using capsules containing coffee powder has reached a fast increasing commercial success due to the convenience of the coffee preparation, the cleanliness and the quality of the coffee obtained. In particular, for short and medium size coffee such as ristretto (25 ml), espresso (40 ml) or lungo (110 ml), certain existing coffee systems on the market enable to deliver coffees of high quality with a diversified aroma and taste but also a head of pure coffee foam with a uniform and smooth texture also called ‘crema’. The aroma and taste variations can generally be obtained by a careful selection of different blends of roast and ground coffee coming from various origins. Generally, the best short coffee extract is obtained under relatively high pressure of extraction (10-20 bars) and in a relatively short time (less than 60 seconds).

An appealing texture of crema generally exhibits a shiny visual appearance and a uniform and very smooth texture without (too many) visible bubbles. The texture should also be persistent for a few tenths of seconds. If the bubbles collapse too rapidly or aggregate into larger ones, the coffee crema loses thickness and the texture providing the attractive mouth feel is poor.

A coffee of longer size (i.e., about 230 ml) is usually not extracted at high pressure to avoid an over-extraction and/or the extraction of coffee compounds that can be at the origin of an undesirable taste.

A solution for making a long coffee from a capsule may consist in making a smaller coffee volume than the final targeted volume under high pressure conditions and, adding hot water directly in the liquid coffee extract during or after coffee extraction. This method usually delivers what is called an “Americano” coffee. One problem is that the volume of crema is reduced by the addition of hot water. Generally, hot water will cause bubbles to collapse instantaneously or rapidly.

U.S. Pat. No. 5,325,765 describes a sealed filter cartridge adapted for use in an automatic machine such as a coffee brewing machine. The coffee is usually prepared by pre-perforating the cartridge and injecting hot water in the cartridge at relatively low pressure. However, the problem is that the coffee obtained is generally considered as “filter coffee”. It is of relatively low intensity. It also exhibits no crema and forms at best a discontinuous thin soapy layer formed of large bubbles rapidly collapsing. Therefore, this method has proven unable to form an attractive crema on a long cup of coffee.

Therefore, to date, it does not exist a long coffee liquid extract, obtained by extraction of roast and ground coffee from a capsule in a coffee machine, which exhibits a thick and stable head of foam (hereafter ‘crema’) that would be very appealing for coffee gourmets. It also does also not exist a method for preparing by extraction of roast and ground coffee with hot water in a capsule coffee system, such a long coffee extract. It also does not exist a capsule for a coffee machine capable of delivering such long liquid coffee extract.

The purpose of the present invention is to propose a method for providing from a single-use capsule, processed in a coffee machine, a long coffee extract with ‘crema’ that presents a shiny visual appearance as well as a thick, homogeneous and uniform (unctuous) texture.

### SUMMARY

The invention is contained in the appended claims here inserted by reference.

The present invention relates to a method for producing a long coffee extract from a capsule in a coffee machine comprising:

providing a capsule containing a predetermined dose of roast and ground coffee and the machine supplying hot water within the capsule,

extracting liquid coffee extract from the capsule by rotating the capsule about its central axis in the machine for centrifuging and extracting the liquid coffee extract towards the periphery of the capsule while the machine continuing supplying hot water,

the machine collecting the liquid coffee extract from the capsule and dispensing the coffee extract in a receptacle;

wherein the liquid coffee extract is formed with coffee foam (i.e., ‘crema’) which exhibits, in a receptacle of reference, an initial height higher than 15 mm in the receptacle, such coffee foam being stable by retaining more than 50% of its initial height at 180 seconds after extraction and,

wherein the roast and ground coffee has a weight of from 11 to 14 grams, a mean particle size D_{4,3} of from 200 to 500 micrometer and a roasting degree of from 50 to 80 CTN.

It was surprisingly found that a persistent coffee ‘crema’ can be obtained in a centrifugal extraction process by selecting certain coffee parameters, in particular, the weight, the coffee granulometry and the coffee roasting value.

The liquid coffee extract is formed with coffee foam which exhibits, in a receptacle of reference, an initial height even higher than 20 mm, preferably comprised between 20 and 35 mm, most preferably between 25 and 30 mm.

The liquid coffee extract is stable after extraction by retaining even more than 60%, most preferably more than 64% of its initial height at 180 seconds after extraction.

In particular, it was surprisingly found that the coffee roasting degree influences the quality of the coffee crema, and particular, darker roasting were preferred. Roasting is generally a heat treatment on green coffee beans which modifies the physico-chemical bean properties (density, microstructure, oil migration, etc.) thereby resulting in the development of the aroma, flavour and colour of the beans.

Preferably, optimal results were obtained when the roast and ground coffee has a roasting degree of from 55 to 70 CTN, more preferably of from 58 to 65 CTN. Such roasting degree essentially corresponds to a dark roasted coffee powder.

Preferably, the roast and ground coffee has a mean particle size D_{4,3} of from 200 to 350 micrometer. Preferably, roast and ground coffee has a fines content of from 10 and 30% in volume. Preferably, the fines content is preferably of from 15 to 30% in volume.

Preferably, the roast and ground coffee has a weight of from 12 to 13.5 grams. With such a coffee weight, it is possible to produce coffee extract with excellent crema, high intensity but without over-extraction.

Surprisingly, it was found that under these selected product and extraction process conditions, a persistent coffee crema can be obtained for a long coffee extract while also significantly avoiding the coffee over-extraction that generates undesired bitter or unpleasant flavour and/or taste notes.

The liquid coffee extract as obtained by the method of the invention provides a long coffee liquid extract with good intensity and body. Generally, the intensity can be set higher than for long filter coffee. In particular, the liquid extract has preferably a coffee yield of from 20 to 30% wt. Preferably, the liquid extract has a total solids of from 1.0 to 1.55% wt, more preferably of from 1.25 to 1.55% wt. The coffee is not over-extracted so that the coffee is not bitter and the natural coffee aromatic notes (such as cereal, fruity or juicy notes) are promoted.

The quality of coffee crema can be impacted by the water and/or coffee temperatures. The control of temperatures preferably involves the temperature of water before it is supplied to the capsule (i.e., “hot water temperature”) and the temperature of coffee as dispensed in the coffee receptacle (i.e., “in-cup temperature”).

Preferably, hot water is heated before being supplied within the capsule at temperature comprised of from 70 to 95° C., more preferably, of from 75 to 90° C. In addition, the coffee extract is kept warm when collected to be dispensed at in-cup temperature of the coffee extract above 60° C., preferably above 65° C., most preferably of from 70° C. to 80° C. The in-cup temperature is a compromise between the need to not reduce the stability of crema with a too high temperature and the need to serve a coffee sufficiently hot for the consumer.

The in-cup temperatures are preferably controlled by controlling the temperature of the collecting means which collects the liquid extract and/or of the dispensing means such as the coffee outlet of the machine. For instance, the collecting means can comprise an annular U-shaped collector associated with a heating means such as described in co-pending international patent application WO2010/089329.

The extraction of coffee is generally obtained by rotating the capsule about its central axis in the coffee machine and passing hot water through the roast and ground coffee in the direction from the center to the periphery of the capsule. In other words, the extraction is obtained by creating centrifugation forces on the liquid circulating through the bed of coffee in the capsule; such forces generating a gradient of pressure of liquid which is prone to extract the coffee solid and volatile compounds from the coffee particles. The formed coffee extract is moved to the periphery of the capsule where it leaves the capsule through a plurality of peripheral outlets. Such peripheral outlets may, for instance, be perforated by perforated means of the machine and/or be pre-made before insertion of the capsule in the machine.

In the preferred method, the hot water is supplied in the capsule until the capsule is filled under pressure with hot water.

In the water filling step, the volume of water which is supplied in the capsule may vary but generally is sufficient to fully wet the coffee powder. The flow rate of the water in the filling step is controlled to not exceed a certain pressure in the capsule and to prevent blocking of the coffee flow. In general, the flow rate is lower than the flow rate during the subsequent coffee extraction step. Preferably, the water is filled in the capsule at a flow rate of about 80 to 150 ml/min. Such controlled hot water filling enables to improve the release of the coffee volatile compounds during extraction. The suitable prefilling volume of water may vary but is preferably about 0.5 to 3 times the net volume of roast and ground coffee in the capsule.

Advantageously, during extraction of the coffee extract from the capsule, the flow of coffee extract passes a flow restriction means. The flow restriction means is preferably provided at or immediately close to the annular periphery of the capsule. The flow restriction means ensures a sufficient residence time of liquid in the capsule and an improved extraction of the coffee compounds. The restriction means can be formed by a spring-biased pressure ring that engages on the capsule to hinder the flow of coffee extract and is lifted to open a flow path under the effect of the pressure of the coffee extract acting thereon.

This method surprisingly shows a great ability for producing high volume of unctuous ‘crema’ while still maintaining the characteristics of the coffee extract (yield, total solids) within preferred ranges.

The mean flow rate of the hot water during extraction is more preferably of from 80 to 250 ml/min, even more preferably of from 120 to 200 ml/min. The flow rate can be controlled to control the coffee intensity and avoid coffee over-extraction. The flow rate of hot water can depend on the coffee blend which is selected. In a possible mode, the hot water flow rate is varied during extraction such as be increased or decreased in a continuous manner or stepwise. Moreover, the hot water flow rate can be controlled during at least two separate phases having different flow rate thresholds, even more preferably three separate phases with two or three different thresholds of flow rates.

In the preferred method, the capsule is rotated to provide centrifugal forces in the capsule that forces heated water through the coffee and enables the coffee to be extracted at relatively low pressure. Preferably, during extraction of the liquid coffee extract, the mean value of the water pressure (“mean pressure”) supplied within the capsule is of from 700 mbar to 1 bar.

The flow rate is influenced by the pressure in the system and the rotational speed. For this, the rotational speed is controlled to match the target(s) of water flow rate. The capsule can be rotated at a rotational speed is of from 3000 to 6000 rpm during extraction. The rotational speed can be increased or decreased during extraction to match a set value of flow rate or an increasing or decreasing profile of flow rates. In a possible mode, the flow rate is varied during extraction by applying two or three sequential phases; each having a set value of flow rate or an increasing or decreasing profile of flow rate.

The invention further relates to a single-use capsule for producing a long coffee extract with a thick and stable coffee foam in a coffee machine containing a predetermined dose of roast and ground coffee having a weight of from 11 to 14 grams, a mean particle size D_{4,3} of from 200 to 500 micrometer and a roasting degree of from 50 to 80 CTN, and, preferably a fines content of from 10 to 30% in volume.

Preferably, the roast and ground coffee has a mean particle size D_{4,3} of from 200 to 350 micrometer.

Preferably, the roast and ground coffee has a fines content of from 15 to 30% in volume.

The capsule of the invention is extractable in a centrifugal coffee machine to deliver a long coffee extract formed with coffee foam (‘crema’) which exhibits in a receptacle of reference an initial height larger than 15 mm, such coffee foam being stable after extraction by retaining more than 50% of its initial height at 180 seconds.

Preferably, the capsule is extractable to form a liquid coffee extract with coffee foam which exhibits, in a receptacle of reference, an initial height even higher than 20 mm, preferably comprised between 20 and 35 mm, most preferably between 25 and 30 mm.

The capsule is also extractable to form a liquid coffee extract which is stable after extraction by retaining even more than 60% of its initial height at 180 seconds after extraction. The stability is preferably between 60 and 80%.

The capsule preferably may comprise a cup-shaped body forming a cavity containing the roast and ground coffee, a circular annular flange like rim and an upper wall member sealed onto the rim. The upper wall member can be a sealing membrane made of aluminium and/or polymer. The upper wall member may also be a lid or a membane with pre-made inlet and/or peripheral outlets.

In order to reduce oxidation of the coffee powder, the capsule of the invention preferably forms by itself an oxygen-tight package or forms a package with very low oxygen permeability such as using barrier packaging materials such as EVOH and the like. It preferably contains the roast and ground coffee with saturation of the free volume with protective gas such as N₂ and/or CO₂. The capsule may also forms a package permeable to oxygen but sealed by a secondary (over-)package which is oxygen-tight or with exhibits very low oxygen permeability with barrier packaging materials such as EVOH and the like.

The internal volume of the capsule is sized as a function of the amount of roast and ground coffee contained in the capsule and to the volume of water to be received in for filling the capsule for pre-wetting the coffee before extraction. The suitable prefilling volume of water may vary but is preferably about 0.5 to 3 times the net volume of coffee.

The invention also relates to the use of a capsule as aforementioned for the production of a liquid coffee extract.

In particular, the invention relates to the use of a capsule for the production of a long coffee extract in a centrifugal coffee machine in which the capsule is rotated about its central axis for centrifuging and extracting the liquid coffee extract for producing a liquid coffee extract formed with coffee foam (i.e., ‘crema’) which exhibits in a receptacle of reference an initial height larger than 15 mm, preferably more than 20 mm, such coffee foam being stable after extraction by retaining more than 50%, preferably more than 60%, of its initial height at 180 seconds.

The invention further relates to a liquid coffee extract having a volume of 230 (+/−5) ml obtained by extraction of roast and ground coffee from a capsule in a coffee machine, with a head of foam (i.e., crema) which exhibits, in a receptacle of reference, an initial height higher than 15 mm, preferably more than 20 mm in the receptacle of reference, such coffee foam being stable by retaining more than 50%, preferably more than 60%, of its initial height at 180 seconds after extraction.

The crema stability is preferably between 60 and 80%.

Preferably, the liquid coffee extract of the invention has a coffee yield of from 20 to 30% wt.

Preferably, the liquid coffee extract of the invention a total solids of from 1.0 to 1.55% wt, preferably of from 1.25 to 1.55.

Definitions

In the present description, terms are utilized for which the definitions are given below.

In the context of the present invention, the term “long coffee extract” represents a liquid coffee extract of 230 (+/−5) ml.

The “extraction” is defined as the period the liquid coffee extract is dispensed from the capsule and collected in the receptacle.

The “coffee weight” represents the weight of the predetermined dose of roast and ground coffee contained in the capsule in the sealed or storage packaging conditions of the capsule.

The “roasting degree” refers to the CTN value converted from a score measured at room temperature by a coffee roast analyzer Agtron E20 CP-II. The Agtron analyzer measures the amount of near-infrared energy at specific wave lengths reflected from the surface of the sample. The score given by Agtron analyzer is converted by the conversion chart “Neuhaus Neotec Colortest vs. Agtron Conversion Chart” given by Modern Process Equipment Chicago, Ill.

The “crema” is defined as the head of foam created on the coffee extract with a creamy texture formed of substantially small bubbles.

The “initial height” of the coffee crema is measured in a “receptacle of reference” (as referred in the present application) having a defined capacity and dimensions illustrated in FIG. 5.

The “stability” of coffee crema is determined by the remaining percentage of the initial height of crema at 180 seconds immediately after dispensing of the coffee extract (or extraction) into the receptacle of reference by the coffee outlet of the machine.

The “mean flow rate” is determined by a flow meter positioned after the water heater and before the water injection needle or injection point in the capsule.

The “mean water pressure” represents the averaged pressure of water above atmospheric pressure in the water dispensing line of the coffee machine after the water heater and before the injection needle or injection point in the capsule. The water pressure is typically measured by a pressure sensor.

The mean diameter D_{4,3} represents the volume mean diameter of the coffee particles. This value is determined by laser diffraction method a Camsizer XT instrument commercialized by Retsch company. The method uses dynamic image analysis (ISO 13322-2) and air pressure dispersion. The measuring method is generally taking more than 250 images per second; each with approximately 1.3 MPixel. The resolution is about 1 micron. The width of analysis area is 25 mm (FoV). This equipment uses the principle of digital image processing.

The “fines” are all the small coffee particles having a diameter below or equal to 100 microns when measured by the Camsizer XT equipment. The percentage of fines in the coffee powder is expressed in volume.

The “extraction yield” is defined as the total weight of total solids in the coffee extract divided by the total weight of roast and ground coffee contained in the capsule. This value is expressed in percentage by weight.

$$Yield ( \% ) = \frac{Tc ( \% ) * Weight extract}{coffee weight}$$

The “total solids” is defined as the weight of extracted solids contained in the liquid coffee extract divided by the total weight of the liquid coffee extract. This value is expressed in percentage by weight.

The “hot water temperature” is determined by the temperature of water inside the heater or of the heating block of the heater in contact with water as determined by a temperature sensor.

The “in-cup temperature” is determined by the temperature of the liquid coffee extract at its center immediately after being dispensed in the receptacle from the coffee machine. The temperature is measured at room temperature (23+/−3° C.). The temperature is measured with a calibrated temperature sensor (thermocouple K type supplied by Thermocontrol) in the receptacle of reference.

### BRIEF DESCRIPTION OF THE DRAWINGS

FIG. 1 represents a side view of a beverage capsule according to the invention for producing a long coffee extract;

FIG. 2 represents a coffee machine in cross-section comprising a capsule of FIG. 1;

FIG. 3 is an enlarged cross-section view of the coffee machine including the capsule of FIG. 1;

FIG. 4 is an enlarged cross section view of FIG. 3 during centrifugation of the liquid from the capsule in the coffee machine;

FIG. 5 represents a receptacle of reference for the determination of the characteristics of coffee crema of the liquid coffee extract;

FIG. 6 shows pictures for a long coffee liquid extract with crema just after dispensing for determination of the initial height (left) and after a predetermined pausing time (e.g., t=180 seconds) for determination of the crema stability (right);

FIG. 7 is a graph showing the influence of the crema height as a function of the roasting degree for the centrifugal coffee system;

FIG. 8 is a graph showing the crema stability for different dark roasted coffee capsules;

FIG. 9 is a graph showing the crema height for different dark roasted coffee capsules;

FIG. 10 is a graph showing the crema stability for different dark roasted coffee capsules;

FIG. 11 is a graph showing the crema height for different medium roasted coffee capsules;

FIG. 12 is a graph showing the crema stability for different medium roasted coffee capsules;

FIG. 13 is a graph showing the crema height for different light roasted coffee capsules;

FIG. 14 is a graph showing the crema stability for different light roasted coffee capsules.

### DETAILED DESCRIPTION

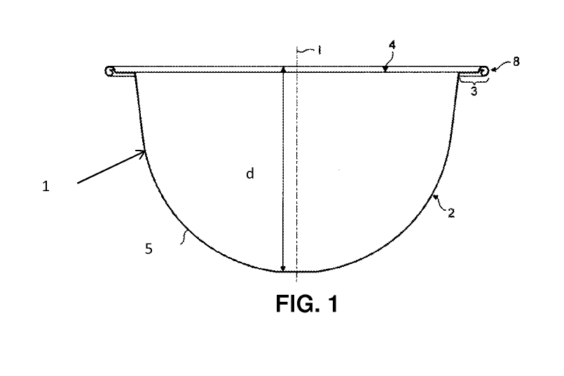

FIG. 1 relates to a preferred, non-limiting, embodiment of a capsules 1 according to the invention. The capsule is for a single use and designed to deliver a beverage from a beverage producing device or coffee machine. The capsule preferably comprise a cup-shaped body 2, a circular, annular flange-like rim 3 and an upper wall member of disc form, preferably, a perforable membrane 4. The cup-shaped body 2 may be shaped as a bowl as illustrated or other forms. Thereby, the membrane 4 and the body 2 enclose an enclosure respectively ingredient compartment 6. As shown in the figure, the membrane 4 is preferably connected onto an inner annular flange portion of the rim 3 that is for example between 1 to 5 mm. The membrane 4 is connected to the rim 3 of the body by a seal such as a heat or ultrasonic weld line.

The rim 3 is not necessarily horizontal as illustrated. It can be slightly bent, upwards or downwards, in order to increase the resistance of the seal to the increasing pressure pushing on the membrane with time, due to degassing of the capsule substance or ingredient with time.

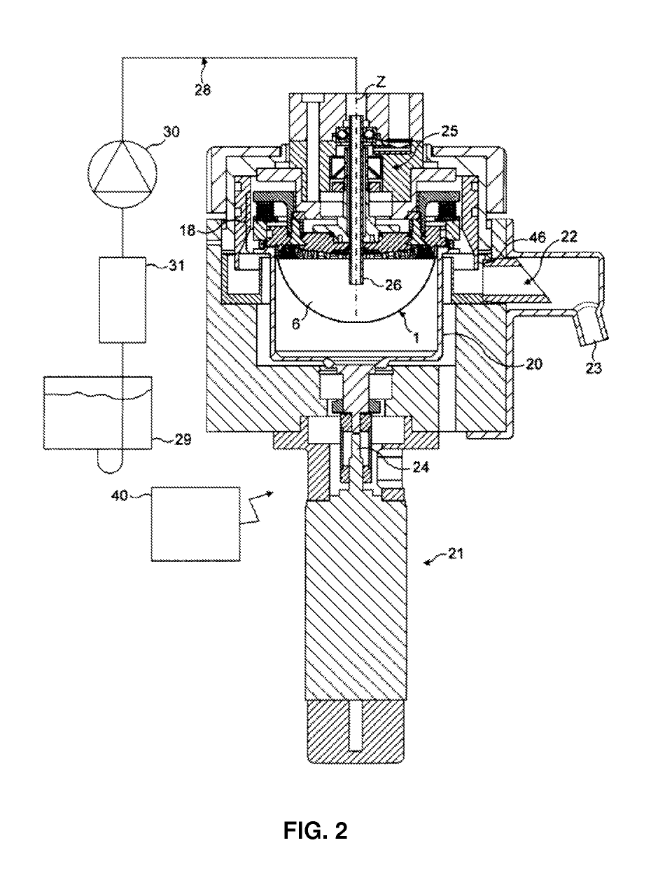

The rim 3 of the capsules preferably extends outwardly in a direction essentially perpendicular (as illustrated) or slightly inclined (if bent as aforementioned) relative to the central axis of symmetry I of the body corresponding to the axis of rotation Z of the capsule 1 in the beverage production device (see FIG. 2). Thereby, the axis of symmetry I is aligned with the axis of rotation Z during centrifugation of the capsule in the brewing device.

It should be understood that the shown bowl-shaped embodiment of the capsule is just an exemplary embodiment and that the capsule in particular the capsule body 2 according to the invention can take various different shapes. The body 2 has a convex portion 5 of depth d. However, the portion 5 may as well be a truncated or a cylindrical portion or a combination of portions of different shapes such as truncated, cylindrical, spherical, etc.

The body 2 of the capsules is preferably rigid or semi-rigid. It can be formed of a food grade plastic, e.g., polypropylene, with a gas barrier layer such as EVOH and the like or aluminium or a laminate of plastic and aluminium, such as aluminium-PP (polypropylene) laminate, wherein preferably PP forms the inner layer of the laminate and aluminium forms the outer layer of the laminate. Additional lacquers or colour layers can be provided. The membrane may also be formed of paper and plastic, paper and aluminium or a combination of paper, aluminium and plastic. Plastic also includes biodegradable plastics such as crystallized PLA or equivalent. The membrane 4 can be made of a thinner material such as a plastic film also including a barrier layer or aluminium or a combination of plastic and aluminium. The membrane 4 is usually of a thickness between 10 and 250 microns, for example. The membrane is perforated for creating the water inlet as will be described later in the description. The membrane also further comprises a perforable peripheral area.

Instead of the membrane 4, the capsules 1 may as well comprise rigid, semi-rigid or flexible engagement lid member which preferably has the form of a disc comprising a central portion having an inlet port for enabling the introduction of a water injection member and a peripheral portion having circumferentially arranged outlet openings.

For instance, the outlet openings can be formed by an annular layer of filter paper and/or plastic fabric. The inlet port and outlet openings are thereby premade before insertion of the capsule in the device. They can be covered by a removable gas-tight layer before insertion such as an overwrapping package or a peelable membrane.

The capsule 1 is intended for delivery of a long-size coffee, more particularly, liquid coffee extract of 230 ml. The long-size coffee capsule 1 preferably contains an amount of ground coffee between 11 and 14 grams. The filling level of substance in the capsule and /or volume of the capsule is also set to ensure the filling of hot water during a pre-wetting step.

Preferably, the capsules in the set according to the invention may contain different blends of roast and ground coffee or coffees from different origins and/or having different roasting and/or grinding characteristics.

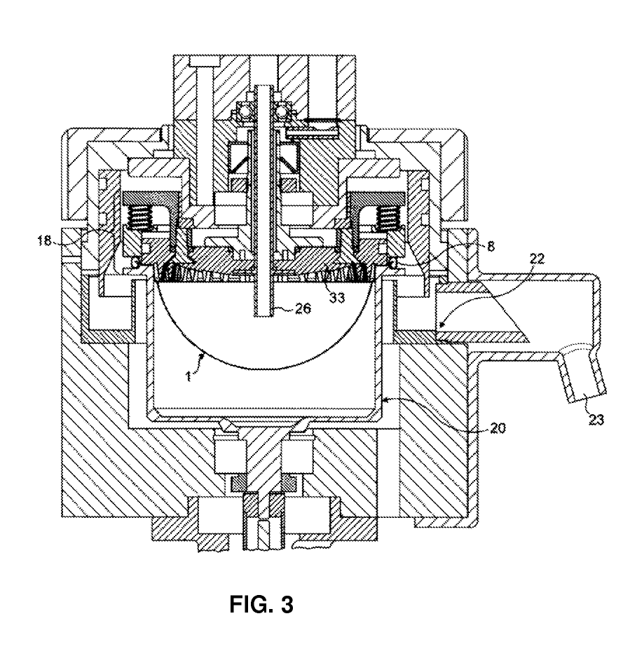

The capsules of the invention, as illustrated in FIGS. 1 to 4, more particularly comprises at its flange-like rim 3, an annular pressure-setting ring 8 protruding, both upwardly and downwardly from the inward flange portion 7. In particular, the pressure-setting ring, whose function will be explained later on, comprises an upper portion extending, in the axial direction of the capsule, above a plane passing by the flange portion 7 and preferably a lower portion 10 extending below the plane still in axial direction of the capsule. By convention, the reference to plane is here taken along the lower surface of the flange portion 7. In the context of the invention, the term “axial direction” refers to any direction aligned or parallel to the central axis I of the capsule. The term “transversal direction” refers to any direction perpendicular to the central axis I or inclined of an angle greater than 45 degrees. The term “lower” and “upper” refer here to the relative positions of the means, as illustrated, when the upper wall 4 of the capsule is oriented upwards and the bottom of the body 2 downwards.

FIG. 2 shows a view of a coffee machine according to an example of the invention in a closed state thereof. Thereby, the device comprises a rotating capsule holder 20, a rotary driving means 21 (e.g., rotary motor), and a collector 22 onto which the centrifuged liquid impacts and drains through a beverage outlet 23. The driving means 21 comprises a rotary motor which is linked to the capsule holder 20 at the bottom side (as illustrated) or top side (not illustrated) through an axle 24 axially connected to the capsule holder. The capsule holder 20 has a circumferential surface that forms a referencing diameter substantially equal to an insertion diameter of the body of the capsule 1 so as to ensure a tight fit of the capsule in the capsule holder 20 without possible radial play. It should be noted that the capsule holder can take various shapes and may also be formed of a simple annular hollow ring.

Furthermore, the device comprises water injection means 25 having an injection member 26 being arranged to perforate the membrane 4 of the capsule 1 in a central portion thereof. As described in WO2008/148604, cited here as reference, the injection means 26 are connected to a liquid circuit 28 comprising a water supply 29 such as a water tank, a pump 30 and waterheating apparatus 31 for providing a predefined volume of heated pressurized water to the capsule 1 during the beverage extraction process. The water is fed in the capsule by injection through the injection member 26 having the form of a hollow needle or tube. Additional heating means (not illustrated) are provided to maintain the coffee extract warm when dispensed in the collector 22. The injection member can be formed of a sharp free end to ensure perforation of the upper wall, if necessary. The device also comprises a series of outlet perforators 27 as described in WO2008/0148604. The outlet perforators are provided at the periphery of an extraction interface 33 which engages against the upper wall of the capsule during closure of the device. Accordingly, outlets are produced in an annular portion of the membrane 4 thereby enabling an extracted (centrifuged) beverage to leave the capsule 1 during the rotational movement thereof.

The device further comprises a control unit 40 which controls the different elements of the device, in particular, the pump 30, heater 31 and rotational speed of the driving means 21. In particular, the control unit is programmed to adjust operational parameters during extraction including (but not limited) to: water pump flow rate, the water temperature, rotational speed and the different coffee preparation phases cycles, i.e., pre-wetting, extraction, drying. Several programs can be designed specifically to different capsules, for example delivering liquid coffee extract having specific intensity and ‘crema’ characteristics. The capsules can comprise an identification code, such as a barcode, radio-frequency tag, etc., for enabling the identification in the device and for setting of operational parameters automatically. In this case, the device comprises suitable code reading means associated to the control unit.

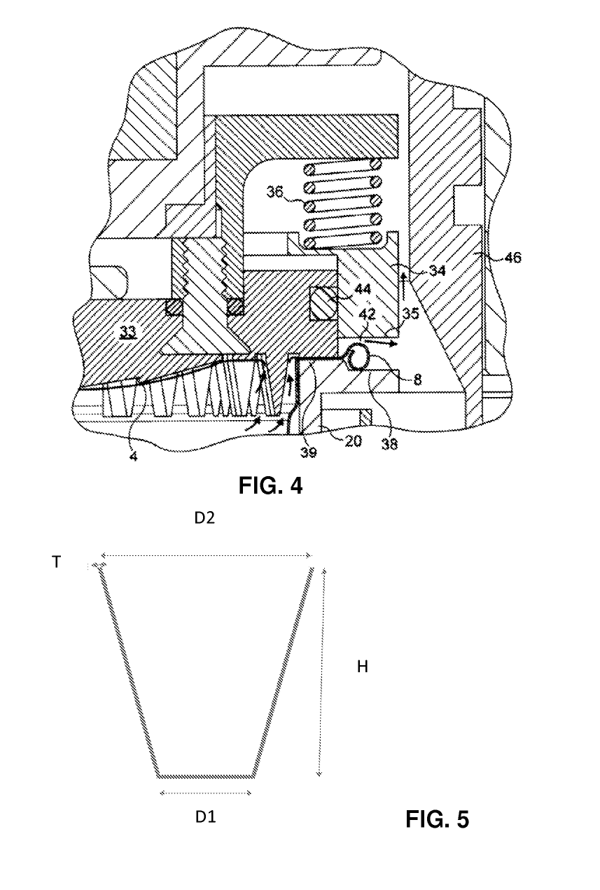

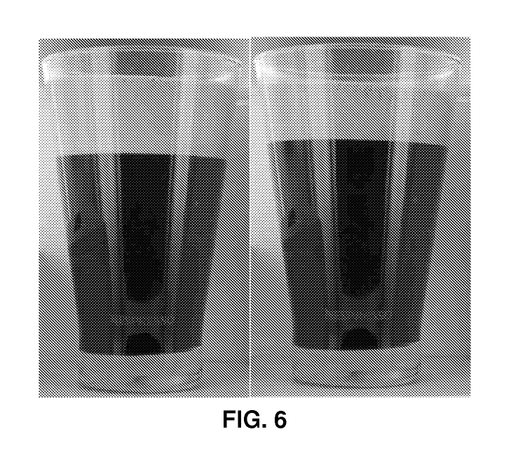

The system of the invention comprises a flow restriction means 18 capable of providing a back-pressure against the centrifuged liquid that leaves the capsule through its outlets (perforated or premade). The valve means 18 is formed by the complementary engagement of the device on the capsule. More particularly (FIG. 4), the device comprises a valve member 34 which is arranged circumferentially relative to the extraction interface 33 and which has a lower annular pressing surface 35.

On the capsule's side, the flow restriction means comprises the pressure-setting ring 8 which is engaged by the annular pressing surface 35 of the valve member 34 of the device. The pressing surface 35 engages onto the upper portion of the pressure-setting ring under a predetermined backpressure. The pressure engagement of the two complementary portions 34, 8 of the flow restriction means is made resilient by means of a spring-biasing means such as springs 36 placed between the valve member 34 and an annular counter-force element 37, connected directly or indirectly to, or part of the extraction interface 33. A spring means 36 (for instance 6 to 10 springs) can be evenly placed at the periphery, between the portion 34 and element 37, such as helical or blade springs in parallel to distribute and balance the preload onto the rim of the capsule evenly.

The valve member 34 and the injection unit 25 are typically movable with respect to the capsule holder 20 (or vice versa) via a closure system (not shown) in order to enable insertion and ejection of the capsule 1 to and from the capsule holder 20 before respectively after the beverage extraction process. Closure system can be a mechanical and/or hydraulic closure mechanism. Moreover, the extraction interface 33, the valve member 34, the capsule 1 and the capsule holder 20 are all rotatable about axis Z during the centrifugation process. The valve member 34 is also made moveable independently from the extraction interface 33 to take into account the different possible thicknesses of the capsules without affecting the relative position of the injection portion when engaged against the capsule. For this, portion 34 can be slidably mounted about extraction interface 33. A joint 44, such as an O-ring, can be provided between the two parts 33, 34 to ensure liquid-tightness of the flow restriction means.

On the capsule's holder side, the pressure-setting ring 8 can be firmly supported by a lowered portion or recess 38 of the supporting edge of the capsule holder 20. The lowered portion or recess 38 is lowered relative to a flange-supporting portion 39 of the edge of the capsule holder which holds the flange portion 7 of the rim.

The extraction of the beverage out of the capsule 1 is obtained by driving the extraction interface 33 of the injection unit 25, the flow restriction means 18, the capsule holder 20 and capsule together, in rotation about axis Z, at a high rotational speed, e.g., between 3500 and 5000 rpm, that can be constant or variable. The rotational speed must be sufficient during extraction to create a centrifugal pressure of liquid in the capsule enabling opening of the flow restriction means as described.

Hot water which is centrally injected into the capsule 1 tends to be guided along the inner surface of the side wall of the body 2, up to the inner side of the membrane 4, and then through the perforated outlet openings created in the membrane 4 by the perforating members 24 then through the valve means 18 between surface 35 and top of the ring 8. Liquid can be filtered by the interstice created between the perforators 27 and the membrane 4 to ensure that most coffee particles are kept in the capsule. Due to the centrifugation of the liquid in the capsule 1, the liquid and the roast and ground coffee powder provided within the capsule are made to interact in order to form a coffee liquid extract. FIG. 4 illustrates the system when beverage is centrifuged out of the capsule and the flow restriction means is opened sufficiently so that liquid passes between the pressure-setting ring 8 and the flow restriction member 34.

Centrifuged beverage is given a sufficient pressure upstream the valve means to open it and create an annular restriction opening 42 for liquid flow to be projected towards the impact wall 46 of the collector at high velocity. Opening of the valve means is again obtained by the liquid forcing the valve member 34 to further urge against the springs 36. It should be noted that a small liquid leakage between the flow restriction means 18 and the ring 8 can be required that helps to vent the gas or air contained in the capsule during the filling of the capsule with water at the beginning of the beverage preparation process (pre-wetting or filling step).

After filling of the capsule with hot water and during the extraction phase, water continues to be fed in the capsule by the water pump at a controlled water flow rate or flow rates. Preferably, the rotational speed is controlled to match a preferred water flow rate of reference. Water flow rate can be measured by a flow meter placed in the fluid circuit downstream of the water pump and controlled by control unit 40. The rotational speed fluctuates during extraction phase to match a flow rate of reference as preset in the control unit. The extraction step can be divided in different successive phases with different flow rate targets or (increasing or decreasing) profiles of flow rates.

At the end of the extraction phase, the water pump may be stopped while centrifugation is maintained to empty the capsule from residual liquid (“drying”).

More information concerning the control of the coffee production in the machine is described in co-pending patent application PCT/EP13/076448.

### EXAMPLES

### Example 1

The following analysis aimed at comparing crema quantity and stability obtained by extracting using centrifugal extraction liquid coffee extracts with different roasting degrees and particle sizes.

Product

Colombian (100% pure Arabica) coffee has been roasted in a Neuhaus Neotec roaster RFB-S by batches of 400 g at different roasting degrees.

The roasting degrees were the following:

100 CTN for “Light roast” (representative of roasting degree range from 110 to 91);

80 CTN for “Medium roast” (representative of roasting degree range from 90 to 71);

60 CTN for “Dark roast” (representative of roasting degree range from 70 to 50).

The weight of the roast and ground coffee in the capsule was 13 g.

The degasing time was 10 min with O₂ content lower than 2% volume.

The characteristics of particle size, measured on the Camsizer XT were the following:

| | Grinding 1 | | Grinding 2 | | Grinding 3 | |
|---|---|---|---|---|---|---|
| | Particle size | % | Particle size | % | Particle size | % |
| | (μm) | fines | (μm) | fines | (μm) | fines |
| Dark | 567 | 5 | 510 | 12 | 504 | 11 |
| roast | 545 | 6 | 505 | 9 | 407 | 21 |
| | 269 | 21 | 289 | 16 | 232 | 30 |
| Medium | 548 | 8 | 486 | 12 | 388 | 26 |
| roast | 512 | 10 | 469 | 14 | 403 | 18 |
| | 302 | 13 | 267 | 21 | 261 | 22 |
| Light | 545 | 8 | 488 | 13 | 438 | 15 |
| roast | 544 | 9 | 479 | 13 | 402 | 18 |
| | 303 | 14 | 284 | 18 | 224 | 29 |

To facilitate coding of sample, the following code table has been used:

| Grinding 1 | | Grinding 2 | | Grinding 3 | |
|---|---|---|---|---|---|
| Particle | % | Particle | % | Particle | % |
| size | fines | size | fines | size | fines |

| | | | |
|---|---|---|---|
| Dark | D1 | D2 | D3 |
| roast | D4 | D5 | D6 |
| | D7 | D8 | D9 |
| Medium | M1 | M2 | M3 |
| roast | M4 | M5 | M6 |
| | M7 | M8 | M9 |
| Light | L1 | L2 | L3 |
| roast | L4 | L5 | L6 |
| | L7 | L8 | L9 |

To summarize, looking to the average values, granulometry values for each roasting degree were:

| | | Range low | Range up |
|---|---|---|---|
| Dark | Particle size (μm) | 385 | 565 |
| roast | % fines | 5 | 25 |
| Medium | Particle size (μm) | 220 | 311 |
| roast | % fines | 12 | 31 |
| Light | Particle size (μm) | 401 | 552 |
| roast | % fines | 6 | 21 |

The coffee yield and total solids of the coffee extracts obtained from the dark coffee roast capsules were determined as follows:

| Dark roast | Yield (%) | Total Solids (Tc) |
|---|---|---|
| D1 | 23.1 | 1.28 |
| D2 | 23.2 | 1.28 |
| D3 | 24.7 | 1.36 |
| D4 | 23.0 | 1.28 |
| D5 | 23.2 | 1.28 |
| D6 | 26.2 | 1.45 |
| D7 | 26.2 | 1.45 |
| D8 | 27.9 | 1.53 |
| D9 | 27.9 | 1.53 |

The coffee yield can vary within a relatively large range. The yield can also be increased with some Robusta coffee in the blend.

Receptacle and Characteristics of Coffee Crema

As illustrated in FIG. 5, the “receptacle of reference” intended for characterizing the crema of the liquid coffee extract in the present invention was a transparent quartz-type glass having a capacity of 370 ml. The glass had a circular internal bottom flat surface of diameter D1 equal to 51.7 mm, a top circular larger opening of diameter D2 equal to 83.7 mm, an internal axial height H of 124 mm and a wall thickness T of 2.3 mm. The side wall was rotationally symmetrical and sloped by widening continuously and essentially rectilinearly from the bottom towards the top opening.

The height of crema was measured directly on the glass wall with a ruler. In the results, the values are expressed in centimeter.

The stability was calculated at 180 seconds just after dispensing of the coffee extract in the receptacle of reference.

Capsule, Machine and Method

The capsule was a capsule as described in relation to FIG. 1.

The machine was a centrifugal coffee machine Nespresso Vertuo™, which centrifugal extraction principle is described in relation with FIGS. 2 to 4.

230-ml liquid coffee extracts were produced. The extraction was repeated five times for each sample.

Crema Results

Influence of Roasting Degree on Crema Volume

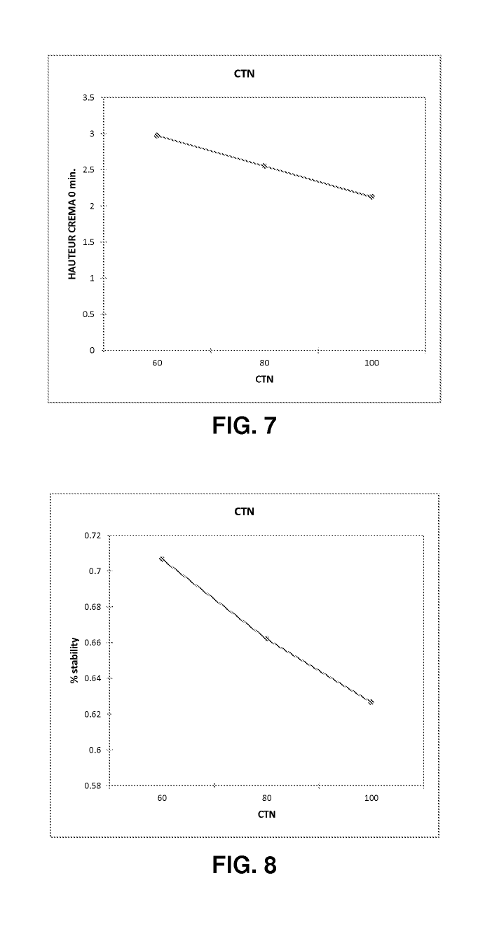

The results are provided in FIG. 7. The X- axis refers to the CTN roasting degree for three values: 60, 80 and 100. The Y-axis refers to the initial height of crema. The roasting degree impact on the crema quantity is significant. The more coffee is roasted, the larger the volume (height) of crema.

Influence of Roasting Degree on Crema Stability

The results are provided in FIG. 8. The X-axis refers to the CTN roasting degree. The Y-axis refers to the stability in percentage. The roasting degree impact on crema stability is significant. The more the coffee is roasted, the more stable is the crema after extraction.

Influence of Particle Size and Fines Content on Crema for Dark Roast Coffee Capsules

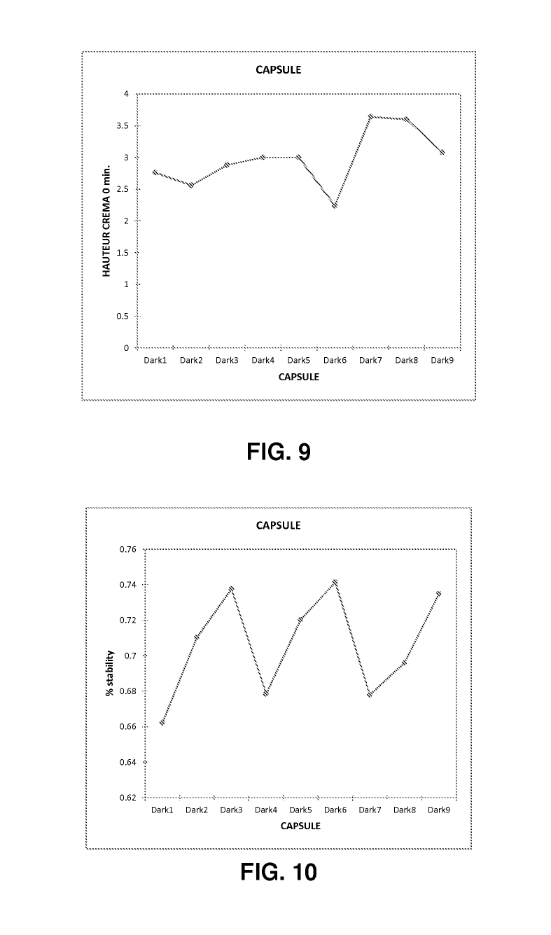

The results on crema height for the dark roasted coffee capsules are provided in FIG. 9. The X-axis refers to the Dark samples D1-D9. The Y-axis refers to the initial height of crema.

The results on crema stability are provided in FIG. 10. The X-axis refers to the Dark roast samples D1-D9. The Y-axis refers to the stability of the crema.

The D7, D8 and D9 samples provided the larger initial height of coffee crema with more than 30 mm. The stability of the samples D2-D9 was not significantly different. Sample D1 had a lower stability.

Influence of Particle Size and Fines Content on Crema for Medium Roast Coffee Capsules

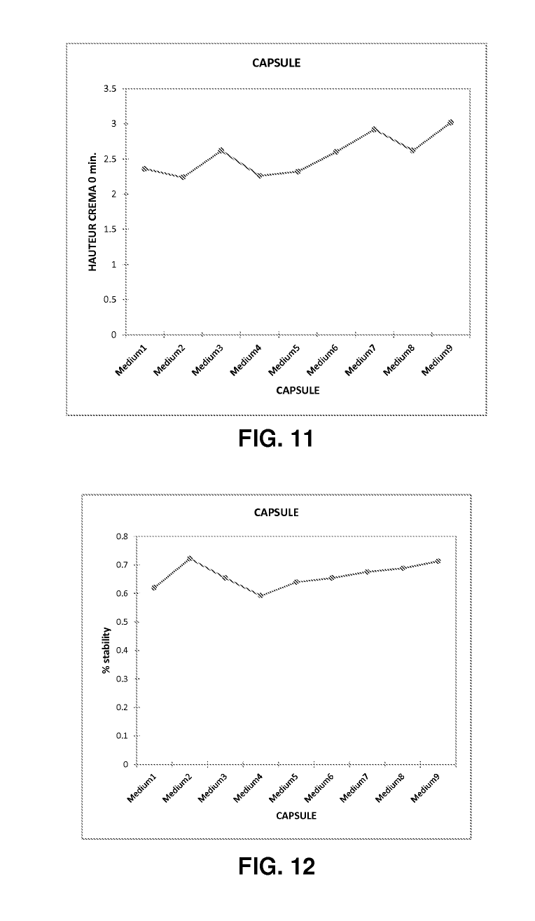

The results on crema height for the medium roasted coffee capsules are provided in FIG. 11.

The results on crema stability are provided in FIG. 12.

The crema stability is not significantly different for samples M2-M9. The height of crema is globally lower than for dark roasted capsules but acceptable. The stability is slightly lower.

Influence of Particle Size and Fines Content on Crema for Light Roast Coffee Capsules

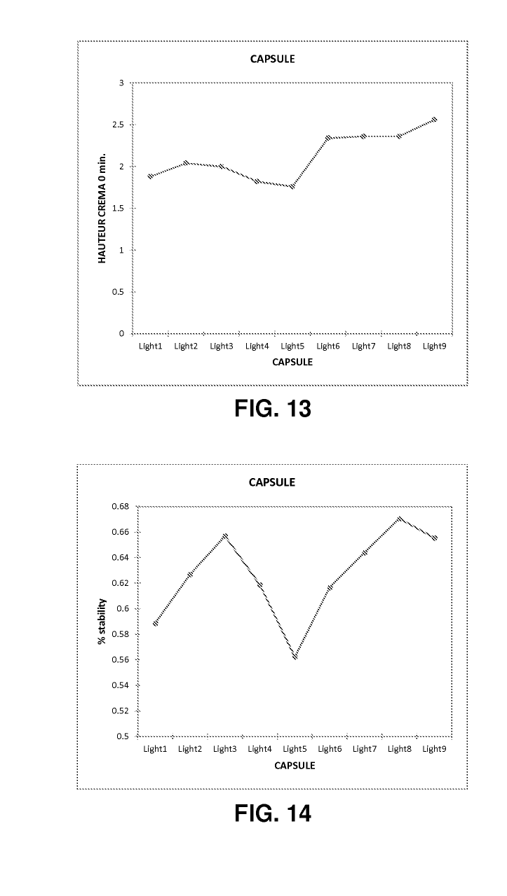

The results on crema volume for the light roasted coffee capsules are provided in FIG. 13. The results on crema stability for the light roast are provided in FIG. 14.

The height of crema is significantly lower than for dark roast coffee capsules.

The stability of crema is significantly lower except for L7, L8 and L9.

Globally, the results show that dark roast coffee capsules provides crema volume in a wide range of particle size and fines contents.

### Example 2

### Influence of Coffee Weight on Crema Quality

The type of capsules and machine were the same as for example 1.

For this example, half-decaffeinated coffee was used.

The water temperature during coffee extraction was set at 83° C. The in-cup coffee temperature was 75° C. The flow rate for capsule Y was 168 ml/min and the extraction pressure was 910 mbar.

| 230-ml | Coffee Weight | D_{4, 3} | Fine | Yield | Tc |
|---|---|---|---|---|---|
| coffee extract | (grams) | (microns) | (% vol.) | (% wt.) | (% wt.) |
| Comparative | | | | | |
| Capsule X1 | 10 | 448 | 13.5 | 25.4 | 1.1 |
| Capsule X2 | 10 | 398 | 11.8 | 27.6 | 1.2 |
| Invention | | | | | |
| Capsule Y | 13 | 462 | 9.8 | 24.03 | 1.4 |

The crema results for the three samples are reported in the following table.

| | Crema initial | Stability (%) at |
|---|---|---|
| | height (cm) | 180 seconds |
| Comparative | | |
| Capsule X1 | 1.76 | 53.4 |
| Capsule X2 | 1.52 | 28.9 |
| Invention | | |
| Capsule Y | 2.32 | 58.6 |

These results show that the quality of crema is dependent on the coffee weight in the capsule. Capsules with 10 grams roast and ground coffee powder produce coffee extracts exhibiting generally smaller crema but also importantly poor stability.

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

1. Method for producing a long coffee extract from a capsule in a coffee machine comprising:
providing a capsule containing a predetermined dose of roast and ground coffee and the machine supplying hot water within the capsule;
extracting liquid coffee extract from the capsule by rotating the capsule about its central axis in the machine for centrifuging and extracting the liquid coffee extract towards the periphery of the capsule while the machine continuing supplying hot water;
the machine collecting the liquid coffee extract from the capsule and dispensing the coffee extract in a receptacle;
the liquid coffee extract is formed with coffee foam which exhibits, in a receptacle of reference, an initial height greater than 15 mm in the receptacle, such coffee foam being stable after extraction by retaining more than 50% of its initial height at 180 seconds; and
the roast and ground coffee has a weight of from 11 to 14 grams, a mean particle size D_{4,3} of from 200 to 500 micrometer and a roasting degree of from 50 to 80 CTN.

2. Method according to claim 1, wherein the roast and ground coffee has a roasting degree of from 55 to 70 CTN.

3. Method according to claim 1, wherein the roast and ground coffee has a mean particle size D_{4,3} of from 200 to 350 micrometer and a fines content of from 10 and 30% vol.

4. Method according to claim 1, wherein the roast and ground coffee has a weight of from 12 to 13.5 grams.

5. Method according to claim 1, wherein the liquid extract has a coffee yield of from 20 to 30% wt.

6. Method according to claim 1, wherein the liquid extract has a total solids of from 1.0 to 1.55% wt.

7. Method according to claim 1, wherein hot water is heated before being supplied within the capsule to a temperature of from 70 to 95° C.

8. Method according to claim 1, wherein the coffee extract is kept warm when collected to be dispensed at in-cup temperature of the coffee extract above 60° C.

9. Method according to claim 1, wherein the hot water is supplied in the capsule until the capsule is filled under pressure with hot water before the capsule is rotated at an extraction rotational velocity for extraction of the liquid coffee extract.

10. Method according to claim 1, wherein during extraction of the coffee extract from the capsule, the flow of coffee extract passes a flow restriction means.

11. Method according to claim 1, wherein the mean flow rate of the hot water is of from 80 to 250 ml/min.

12. Method according to claim 1, wherein during extraction of the liquid coffee extract, the means value of the water pressure supplied within the capsule is from 800 mbar to 1 bar.

13. Single-use capsule for producing a long coffee extract with a thick and stable coffee foam in a coffee machine containing a predetermined dose of roast and ground coffee having a weight of from 11 to 14 grams, a mean particle size D_{4,3} of from 200 to 500 micrometer and a roasting degree of from 50 to 80 CTN, and preferably a fines content of from 10 to 30% vol.

14. Capsule according to claim 13, wherein the roast and ground coffee has a mean particle size D_{4,3} of from 200 to 350 micrometer and a fines content of from 15 to 30% vol.

15. Capsule according to claim 13, wherein the capsule is extractable in a centrifugal coffee machine to deliver a long coffee extract formed with coffee foam which exhibits in a receptacle of reference an initial height greater than 15 mm, such coffee foam being stable after extraction by retaining more than 50% of its initial height at 180 seconds.

16. Use of a capsule according to claim 13, for the production of a long coffee extract in a centrifugal coffee machine in which the capsule is rotated about its central axis for centrifuging and extracting the liquid coffee extract for producing a liquid coffee extract formed with coffee foam which exhibits in a receptacle of reference an initial height greater than 15 mm, such coffee foam being stable by retaining more than 50% of its initial height at 180 seconds after extraction.

17. A liquid coffee extract having a volume of 230 (+/−5) ml obtained by extraction of roast and ground coffee from a capsule in a coffee machine, with a head of foam which exhibits, in a receptacle of reference, an initial height greater than 15 mm, such coffee foam being stable by retaining more than 50% of its initial height at 180 seconds after extraction.
